(19) United States
(12) Patent Application Publication
(10) Pub. No.: US 2010/0269462 A1
(43) Pub. Date: Oct. 28, 2010

(54) Filter with compressible housing

(76) Inventor: Nicholas Brentnall, Cheltenham (GB)

Correspondence Address: IRA S. DORMAN, 330 ROBERTS STREET, SUITE 200, EAST HARTFORD, CT, 06108, US

(21) Appl. No.: 12/798,589

(22) Filed: Apr. 7, 2010

(30) Foreign Application Priority Data
Apr. 24, 2009 (GB) 0907015.2

(51) Int. Cl. B01D 46/42

(52) U.S. Cl. 55/475

(57) ABSTRACT

A filter comprises first and second housing components (1, 3) slidable relative to each other and defining a filter chamber within the housing components. An inlet (7) for a fluid to be filtered is provided in at least one of the first and second housing components, and a filter element (11, 13) is provided within the filter chamber. The filter element is adapted to provide a space (15) between the inlet and the filter element for the accumulation of solid material in the fluid to be filtered, whereby sliding movement between the first and second housing components causes the volume of the filter chamber to vary.

### BACKGROUND TO THE INVENTION

Many vacuum cleaners incorporate filters which filter out dust from the air which has passed through a primary dust-collecting mechanism, such as a bag or a cyclone. The filter needs to be cleaned periodically, which involves removing the filter from the vacuum cleaner, removing dust from the filter, washing and drying it, and then re-assembling the filter within the vacuum cleaner. This is a complex procedure for the user of the vacuum cleaner to undertake and it is desirable to simplify the cleaning of the filter.

For vacuum cleaners which employ bags or the like as the primary dust-collecting mechanism, the bag or the like needs to be emptied at regular intervals as it fills with dust. The dust is often only loosely packed, because the compressive force on the dust is only the air passing through the bag or the like. It would be useful to be able to increase the dust-collecting capacity of a vacuum cleaner by providing a bag or the like in which the collected dust can be more effectively compressed.

### OBJECT OF THE INVENTION

It is therefore an object of the present invention to provide a filter with a compressible housing and which overcomes or at least ameliorates one or more of the abovementioned disadvantages.

### SUMMARY OF THE INVENTION

According to the present invention there is provided a filter comprising first and second housing components slidable relative to each other and defining a filter chamber therewithin, an inlet for a fluid to be filtered provided in at least one of the first and second housing components, and a filter element within the filter chamber, wherein the filter element is adapted to provide a space between the inlet and the filter element for the accumulation of solid material in the fluid to be filtered, whereby sliding movement between the first and second housing components causes the volume of the filter chamber to vary.

The inlet may extend into the filter chamber. The inlet may be provided with perforations for the passage of fluid into the filter chamber. An inlet may be provided at opposite ends of the filter.

The first and second housing components may be provided with perforations for the exit of filtered fluid from the filter. Perforations are preferably not provided in the first and/or second filter housings in the region of the space.

A plurality of filter elements may be provided within the filter chamber.

The space may extend substantially across the entire cross-section of the filter chamber.

A seal may be provided between the first and second housing components.

The first and second housing components may be interconnected by way of a screw thread.

Biasing means, such as a coil spring, may be provided to urge the first and second housing components to an expanded configuration of the filter.

For a better understanding of the present invention and to show more clearly how it may be carried into effect reference will now be made, by way of example, to the accompanying drawings in which:

### BRIEF DESCRIPTION OF THE DRAWINGS

FIG. 1 is a perspective view of one embodiment of a filter according to the present invention;

FIG. 2 is a sectional view of the filter shown in FIG. 1 in an expanded configuration;

FIG. 3 is a sectional view of the filter shown in FIG. 1 in a compressed configuration;

FIG. 4 is a diagrammatic sectional view showing a seal between first and second housing components of the filter shown in FIG. 1; and

FIG. 5 shows the filter of FIGS. 1 to 4 provided with biasing means.

### DESCRIPTION OF PREFERRED EMBODIMENTS

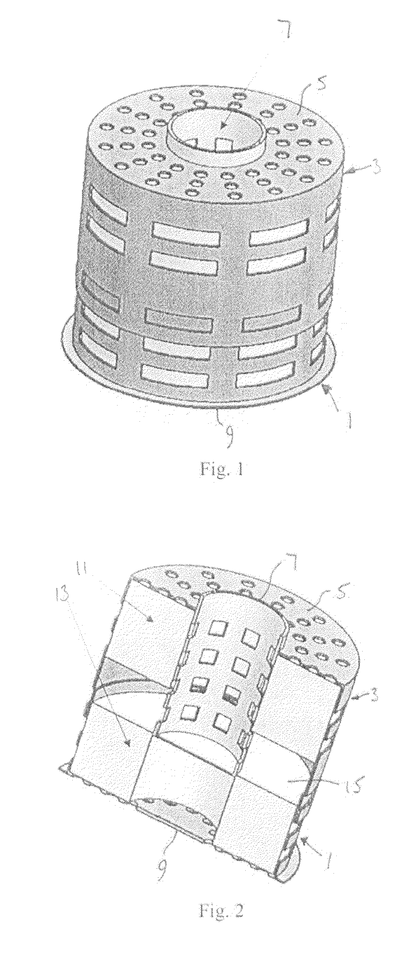

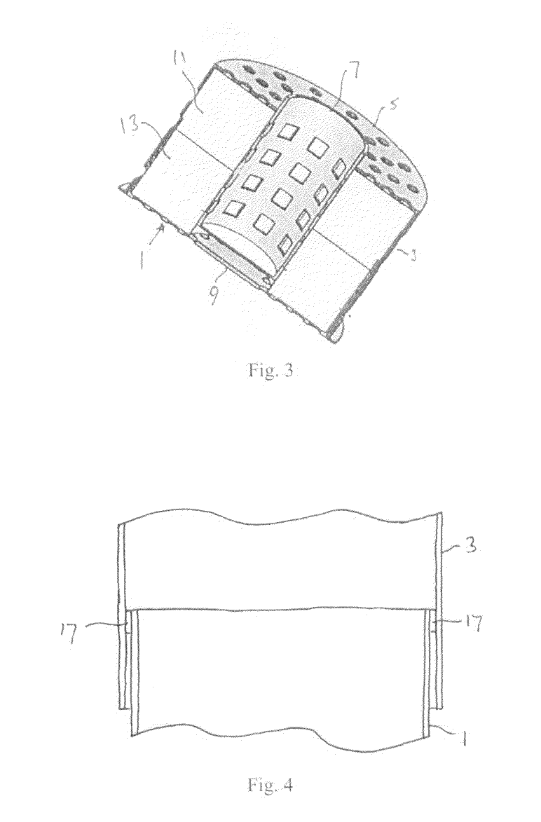

The filter shown in FIGS. 1 to 4 comprises a first housing component 1 and a second housing component 3 which has an internal dimension slightly larger than the external dimension of the first housing component. Thus the second housing component 3 fits over the first housing component 1 and is movable, in particular slidable, relative thereto, the first and second housing components defining a filter chamber therewithin, the volume of which is variable as a result of movement between the housing components. The second housing component 3 has a closed end 5 in the region thereof remote from the first housing component 1 and an inlet 7, for example in the form of a tube, extends into the filter through the closed end of the second housing component. The first housing component 1 also has a closed end 9 in the region thereof remote from the second housing component. The closed end and side walls of the first housing component are perforated to allow the passage of fluid, such as air or water, therethrough. Similarly, the closed end and side walls of the second housing component are also perforated to allow the passage of fluid. The inlet 7 in the illustrated embodiment has a closed end within the chamber formed by the housing components while the side wall of the inlet within the chamber is perforated to allow the passage of fluid into the chamber.

One or more filter elements 11, 13 (two filter elements being shown) are mounted within the filter chamber formed by the two housing components 1, 3, the filter elements each being formed with an aperture therethrough to allow the passage of the inlet. The filter elements may be, for example, made of conventional foam material and/or non-woven material. The filter element or filter elements do not entirely fill the filter chamber formed by the two housing components 1, 3 in the expanded configuration of the filter as shown in FIG. 2, but are dimensioned to provide a space 15 within the filter chamber and extending substantially across the entire cross-sectional area of the chamber. The perforations in the first and/or second housing components 1, 3 are arranged such that there are no perforations in the region of the space 15.

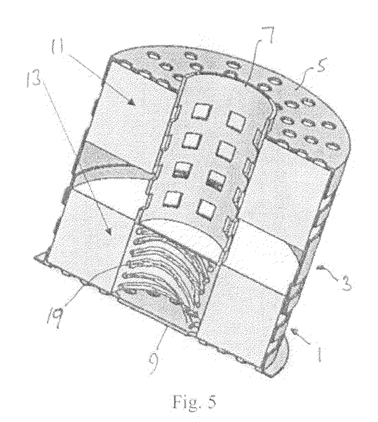

A seal 17, shown diagrammatically in FIG. 4, is provided between the first and second housing components 1, 3. As illustrated, the seal may be provided on the first housing component, but alternatively the seal may be provided on the second housing component or seals may be provided on both the first and second housing components 1, 3. The at least one seal substantially eliminates any leakage which might otherwise occur between the first and second housing components.

Consequently, fluid flow through the filter is from the inlet 7 into one or more of the filter elements 11, 13 (only the element 11 as illustrated) and/or into the space 15, from where the fluid must pass through one or both filter elements 11, 13 to reach the perforations in the first and/or second housing component and to exit the filter.

As illustrated, the first and second housing components 1, 3 are substantially cylindrical with the inlet 7 in the form of a tube of circular cross section extending substantially along the axis of the second housing component. The filter elements 11, 13 are annular in cross section, as is the space 15. However, the filter may have any convenient configuration depending, for example, on the cross-section of an apparatus into which it is to be used. For example, the filter may be square or trapezoidal in configuration.

In use of the filter according to the present invention as shown in FIGS. 1 to 4, fluid, generally in the form of air but alternatively other gases or liquids, passes into the filter by way of the inlet 7. Air then disperses from the inlet into the filter elements 11 and 13 and into the space 15 and passes out of the filter through the perforations in the first and second housing components 1, 3. Solid material in the air is trapped in the filter elements 11, 13 and in the space 15.

After a period of use, solid material builds up in the filter elements 11, 13 and in the space 15 and the filter may be treated in different ways depending on the extent and nature of the solid material.

Where the solid material is primarily in the space 15 and is compressible, the filter can be removed from where it is being used, for example in an appliance such as a vacuum cleaner, and the first and second housing components can be moved together (manually with the filter shown in FIGS. 1 to 4) to move the filter elements 11, 13 together and therefore to reduce the size of the space 15. This has the effect of compressing the solid material within the space thus creating more room for further solid material. The housing components 1, 3 can then be returned to their original configuration and the filter can be replaced so as to accumulate further solid material.

Alternatively, where the solid material requires to be removed from the filter elements 11, 13 and the space 15, the filter is removed from where it is being used and washed in a suitable substance (for example, soapy water for a vacuum cleaner filter) to remove the solid material. The filter elements 11, 13 can then be at least partly dried by compressing the filter to compress, in turn, the filter elements 11, 13 and to squeeze at least a part of the washing substance from the filter elements. If necessary, the filter can then be fully dried before being replaced so as to accumulate fresh solid material.

It should be noted that the filter of FIGS. 1 to 4 can be modified in a number of ways. For example, only a single filter element can be provided, the space 15 being provide in the pathway between the inlet 7 and the filter element. The first and second housing components 1, 3 may be interconnected by way of a screw thread such that manually rotating one of the housing components relative to the other causes axial movement resulting in compression of the contents of the filter chamber within the housing when rotated in one direction and restoration to the original configuration when rotated in the other direction. Alternatively or additionally, as illustrated in FIG. 5, biasing means such as a spring 19, in particular a coil spring, may be provided within the filter and acting between the first and second housing components 1, 3 (for example by way of inlet 7 as illustrated in FIG. 5) so as to bias the filter towards its original, expanded configuration after it has been compressed. Although the figures only illustrate an inlet at one end of the filter, clearly an inlet can be provided at opposite ends of the filter if desired.

As a further modification, the filter may be washed and dried without being removed from its operating location. In such a case, a suitable cleaning fluid is passed through the filter by way of suitable valved conduits to remove the solid material and means, such as a threaded rotating member engaging with one of the housing components, is provided to move the housing components 1, 3 together and apart so as to cause the filter to compress and subsequently expand so as to squeeze any cleaning fluid out of the filter element(s).

I claim:

1. A filter comprising first and second housing components (1, 3) slidable relative to each other and defining a filter chamber therewithin, an inlet (7) for a fluid to be filtered provided in at least one of the first and second housing components, and a filter element (11, 13) within the filter chamber, wherein the filter element is adapted to provide a space (15) between the inlet and the filter element for the accumulation of solid material in the fluid to be filtered, whereby sliding movement between the first and second housing components causes the volume of the filter chamber to vary.

2. A filter as claimed in claim 1, wherein the inlet (7) extends into the filter chamber.

3. A filter as claimed in claim 1, wherein the inlet (7) is provided with perforations for the passage of fluid into the filter chamber.

4. A filter as claimed in claim 1, wherein an inlet (7) is provided at opposite ends of the filter.

5. A filter as claimed in claim 1, wherein the first and second housing components (1, 3) are provided with perforations for the exit of filtered fluid from the filter.

6. A filter as claimed in claim 5, wherein perforations are not provided in the first and/or second filter housings (1, 3) in the region of the space (15).

7. A filter as claimed in claim 1, wherein a plurality of filter elements (11, 13) are provided within the filter chamber.

8. A filter as claimed in claim 1, wherein the space (15) extends substantially across the entire cross-section of the filter chamber.

9. A filter as claimed in claim 1, wherein a seal (17) is provided between the first and second housing components (1, 3).

10. A filter as claimed in claim 1, wherein the first and second housing components (1, 3) are interconnected by way of a screw thread.

11. A filter as claimed in claim 1, wherein biasing means (19) is provided to urge the first and second housing components (1, 3) to an expanded configuration of the filter.

12. A filter as claimed in claim 11, wherein the biasing means comprises a coil spring (19).
